(19) United States
(12) Patent Application Publication
(10) Pub. No.: US 2006/0026937 A1
(43) Pub. Date: Feb. 9, 2006

(54) Filter assembly including foam and pleated media

(76) Inventor: Jon Garth Nichols, Stedman, NC (US)

Correspondence Address: CARLSON, GASKEY & OLDS, P.C., 400 WEST MAPLE ROAD, SUITE 350, BIRMINGHAM, MI, 48009, US

(21) Appl. No.: 10/913,900

(22) Filed: Aug. 6, 2004

(51) Int. Cl. B01D 46/00

(52) U.S. Cl. 55/486

(57) ABSTRACT

A filter assembly includes a pleated paper filter element and multiple foam layers. One of the foam layers adjoins the pleated paper filter element. The foam layers filter coarse debris while the pleated paper filter element filters finer debris.

### BACKGROUND OF THE INVENTION

This invention relates to a filter assembly, for example, for an automotive air filtration system.

Filter assemblies are used in various applications, such as for various systems of automobiles. For example, an air induction system for an automobile uses a filter assembly to filter out debris from the air entering the engine to reduce wear and prolong the life of the engine.

There are several common varieties of filter assemblies for an automobile air induction system. One type of filter assembly utilizes multiple layers of foam secured to one another. Each layer of foam filters a minimum debris size that is different from the minimum debris size filtered by the other foam layers. No paper or pleated media layer is used. While such an arrangement may be efficient in its debris removal, the pressure drop across the filter assembly is unacceptable in order to meet a desired efficiency. That is, to achieve the desired efficiency, a more dense foam must be used for at least one layer, which greatly restricts airflow through the filter assembly.

Another type of filter assembly utilizes a single pleated paper filter element having a rectangular configuration. This type of filter arrangement has a desirable efficiency with very little pressure drop. No foam layer is used. However, this filter assembly is incapable of being packaged in a non-quadrilateral shaped housing. Filter assemblies of a non-rectangular shape could be produced to fit non-quadrilateral shaped housings, but are difficult to and expensive to manufacture reliably.

Another filter assembly utilizes a filter media having longitudinal filtering passages. The filter media is best suited for packing in housings having non-quadrilateral shapes. However, the filter media is specialized and costly to manufacture. The filter assembly does not take advantage of utilizing more readily available materials and manufacturing processes already in place.

Therefore, what is needed is a filter assembly that utilizes inexpensive materials and readily available manufacturing processes, while achieving design objectives such as packaging, efficiency, and minimal pressure drop.

### SUMMARY OF THE INVENTION

The present invention provides a filter assembly including multiple foam layers and a pleated filter media provided by a pleated paper filter element. One of the foam layers adjoins the pleated paper filter element in one of the preferred embodiments. The foam layers filter coarse debris while the pleated paper filter element filters finer debris.

The pleated paper filter element and foam layers are operatively supported by a frame in an example embodiment. The frame also includes a gasket for sealing against a housing of an air induction system. The pleated paper filter element is most easily formed in a quadrilateral shape. For housings having non-quadrilateral shapes, paper element extensions may be arranged to adjoin the pleated paper filter element to provide fine filtering. In one example embodiment, the paper element extensions are integral with the pleated paper filter element cut to a shape that, together with the quadrilateral shaped pleated paper filter element, is complementary to a cross-sectional shape of the housing. The paper element extensions each protrude laterally from a fold. In this manner, the air flowing through the housing does not bypass the paper element extensions.

Accordingly, the present invention provides a filter assembly utilizing a readily available manufacturing process to produce a filter assembly that is efficient and has minimal pressure drop.

### BRIEF DESCRIPTION OF THE DRAWINGS

FIG. 1 is a cross-sectional view of an air induction system having an inventive filter assembly;

FIG. 2 is a cross-sectional view of the filter assembly shown in FIG. 1;

FIG. 3 is an outlet side view of the filter assembly shown in FIGS. 1 and 2;

FIG. 4 is a perspective view of another example of an inventive filter assembly;

FIG. 5 is an exploded side elevational view of the filter assembly shown in FIG. 4; and

FIG. 6 is an outlet side view of a paper element shown in FIGS. 4 and 5.

### DETAILED DESCRIPTION OF THE PREFERRED EMBODIMENT

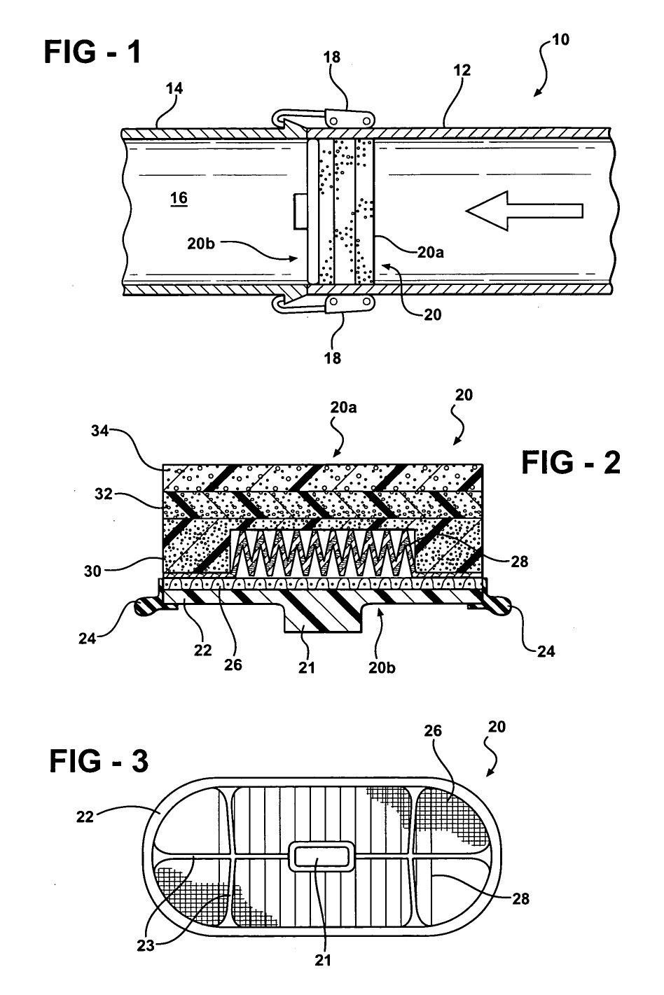

An air induction system 10 is shown schematically in FIG. 1. The air induction system 10 includes first and second housing portions 12 and 14 that together define a passageway 16. The first and second housing portions 12 and 14 are secured together by latches 18 in the example shown. The first and second housing portions 12 and 14 are unlatched from one another for insertion and removal of a filter assembly 20, which filters debris from air flowing through the passageway 16. The arrow in FIG. 1 indicates the direction of airflow through the passageway 16. The filter assembly 20 has an inlet side 20a and an outlet side 20b. Preferably, coarse filtering of debris occurs on the inlet side 20a while a finer debris filtering occurs at the outlet side 20b of the filter assembly 20.

Referring to FIGS. 2 and 3, one example of the inventive filter assembly 20 is shown. The filter assembly 20 includes a frame 22 having a handle 21 for facilitating insertion and removal of the filter assembly 20 relative to the first and second housing portions 12 and 14. The frame 22 operatively supports a filter media, which will be discussed in more detail below. The frame 22 includes a gasket 24 for sealing the filter assembly 20 relative to the first and second housing portions 12 and 14, preventing debris from bypassing the filter assembly 20. The frame 22 also includes webbing 23 for supporting the filter media in the example shown. A wire screen or mesh 26 is supported by the frame 22 and additionally supports the filter media.

The filter assembly 20 includes a pleated media layer 28, which is a pleated paper filter element in the examples shown. Multiple foam layers, such as first, second, and third foam layers 30, 32, 34 are used to supplement the filtering efficiency and capacity of the pleated media layer 28. However, a single foam layer may be used. Utilizing multiple foam layers exclusively is not practical since the resultant pressure drop from a filter assembly having a desired efficiency would be unacceptable.

The first, second, and third foam layers 30, 32, and 34 are constructed from a reticulated foam having varying pore sizes. For example, the first foam layer 30 may have 60 pores per inch for relatively fine filtering, while the second foam layer 32 may have 45 pores per inch for coarser filtering. The third foam layer 34 may have 30 pores per inch for very coarse debris removal. The first foam layer 30 provides capacity for the debris removed. The third foam layer 34 is also useful in creating turbulence and removing water. The foam layers 30, 32 and 34 may also be treated with oil to improve their efficiency.

The first, second, and third foam layers 30, 32, and 34 can be secured together in any suitable manner, such as by using hot melt glue or a tackifier between the layers. The foam used in the first, second, and third layers 30, 32, and 34 is preferably selected to be inexpensive, readily available, and easy to cut into any desired shape. Moreover, manufacturing equipment currently found in many manufacturing facilities can be used.

The first, second, and third foam layers 30, 32 and 34 can easily be configured about the pleated media layer 28 in any number of suitable arrangements. In FIG. 2, the first foam layer 30 is adjacent to the sides of the pleated media layer 28. The second foam layer is both adjacent to sides of the pleated media layer 28 and overlies a top of the pleated media layer 28.

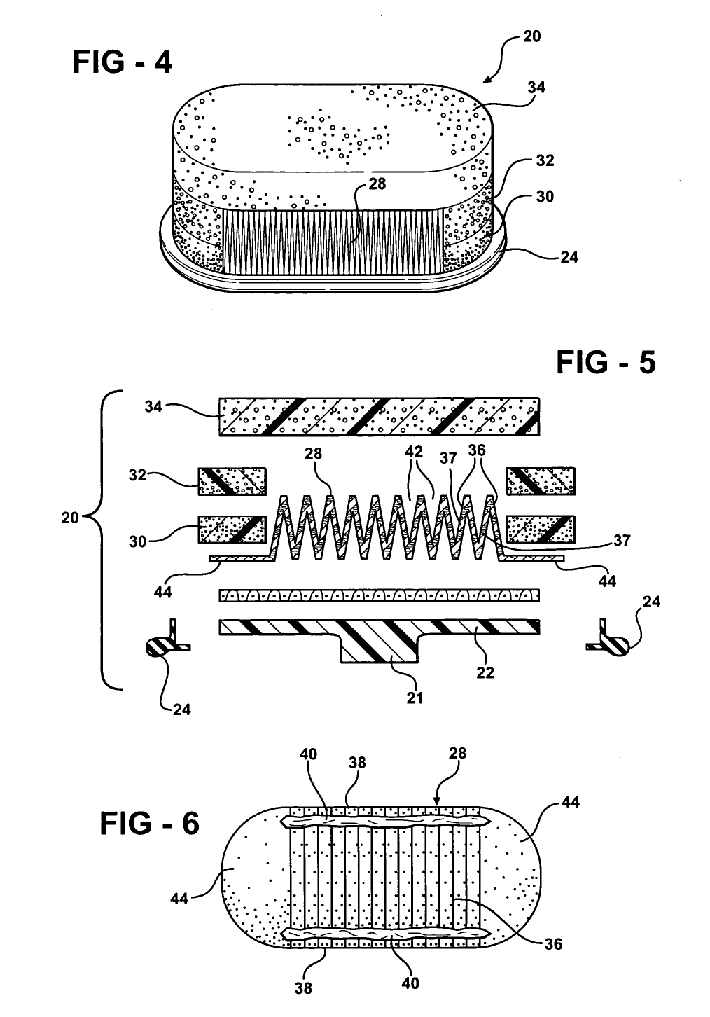

Another example of the filter assembly 20 is shown in FIGS. 4-6. In this example, the first and second foam layers 30 and 32 are adjacent to the sides of the pleated media layer 28. The third foam layer 34 overlies the top of the pleated media layer 28 opposite the outlet side 20b.

The pleated media layer 28 is shown in greater detail in FIG. 6. The pleated media layer 28 is most easily formed into a quadrilateral shape when using a paper element. This technology is currently known for providing rectangular filter assemblies for placement into a rectangular housing. Specifically, the paper element includes multiple opposing folds 36 having walls 37 adjoining the folds 36 to form pockets 42. End portions 38 of the walls 37 are secured, for example, by glue beads 40 to seal the pockets 42. Debris is held in the pockets 42 to provide debris holding capacity.

The walls 37 may be impregnated with a stiffening material and cured, as known, or embossed to provide structural rigidity to the walls 37 so that the pleated media layer 28 maintains its shape during operation.

Extensions 44 are arranged to adjoin the rectangular grouping of pockets 42. The extensions 44 may be integral with the pleated media layer 28 and constructed from the same paper element so that the air must pass through the extensions 44 and not simply through the first, second, and third foam layers 30, 32, and 34 at the sides of the pleated media layer 28. The extensions 44 are used to provide a paper element in areas not covered by the pleated media layer 28.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A filter assembly comprising:
a pleated media layer having a first filtering characteristic for filtering a first minimum debris size; and
a first foam layer proximate to the pleated media layer having a second filtering characteristic for filtering a second minimum debris size greater than the first minimum debris size.

2. The filter assembly according to claim 1, comprising inlet and outlet sides, the pleated media layer in a closer proximity to the outlet side than the first foam layer.

3. The filter assembly according to claim 2, wherein the pleated media layer is exposed at the outlet side.

4. The filter assembly according to claim 2, comprising a second foam layer proximate the first foam layer, the second foam layer in a closer proximity to the inlet side than the first foam layer, the second foam layer having a third filtering characteristic for filtering a third minimum debris size greater than the second minimum debris size.

5. The filter assembly according to claim 1, wherein the pleated media layer includes multiple opposing folds and adjacent walls adjoining the multiple opposing folds to form pockets.

6. The filter assembly according to claim 5, wherein the pleated media layer includes end portions each having a material securing the adjacent walls to one another to seal the pockets.

7. The filter assembly according to claim 6, wherein the pleated media layer is quadrilateral in shape, the pleated media layer and extensions adjoining the pleated media layer providing a non-quadrilateral shape.

8. The filter assembly according to claim 7, wherein the pleated media layer is a paper element.

9. The filter assembly according to claim 7, wherein the extensions are a paper element.

10. The filter assembly according to claim 1, comprising a housing defining a passageway, the pleated media layer and the first foam layer arranged in the passageway for filtering a fluid flowing through the passageway.

11. The filter assembly according to claim 10, comprising a frame, and the pleated media layer and first foam layer operatively supported by the frame, the frame locating the pleated media layer and first foam layer relative to the housing.

12. The filter assembly according to claim 11, wherein the frame includes a handle for facilitating removal of the pleated media layer and the first foam layer from the housing for replacement.

13. The filter assembly according to claim 11, wherein a mesh material is arranged between the frame and the pleated media layer for supporting the pleated media layer.

14. The filter assembly according to claim 10, wherein a gasket is arranged between the housing and at least one of the pleated media layer and the first foam layer for preventing the fluid from bypassing the pleated media layer and the first foam layer.

15. A filter assembly comprising:
a pleated paper filter element; and
multiple foam layers with one foam layer adjoining the pleated paper filter element.

16. The filter assembly according to claim 15, wherein the pleated paper filter element and the multiple foam layers each have filtering characteristics for filtering different minimum debris sizes than one another.

17. The filter assembly according to claim 15, wherein one of the multiple foam layers includes a non-quadrilateral shape.

18. The filter assembly according to claim 17, wherein the pleated paper filter element includes multiple opposing folds and adjacent walls adjoining the multiple opposing folds to form pockets, the pockets together providing a quadrilateral shape.

19. The filter assembly according to claim 18, wherein extensions adjoin the pleated paper filter element, the pleated paper filter element and extensions having the non-quadrilateral shape.

20. The filter assembly according to claim 15, comprising a frame operatively supporting the pleated paper filter element and the multiple foam layers.
